(19) United States
(12) Patent Application Publication
(10) Pub. No.: US 2025/0077886 A1
(43) Pub. Date: Mar. 6, 2025

(54) SYSTEM AND METHOD FOR JOINTLY OPTIMAL INCREMENTAL LEARNING WITH SELF-SUPERVISED VISION TRANSFORMERS

(71) Applicant: Leidos, Inc., Reston, VA (US)

(72) Inventor: Hanna Witzgall, Chantilly, VA (US)

(73) Assignee: Leidos, Inc., Reston, VA (US)

(21) Appl. No.: 18/815,992

(22) Filed: Aug. 27, 2024

Related U.S. Application Data
(60) Provisional application No. 63/579,144, filed on Aug. 28, 2023.

(51) Int. Cl. G06N 3/096; G06N 3/088

(52) U.S. Cl. CPC G06N 3/096; G06N 3/088

(57) ABSTRACT

An incremental learning algorithm, extending Rapid Class Augmentation (“XRCA”), implements an unconstrained, recursive least-squares (RLS) style of optimization that incorporates knowledge of all the past training examples into each optimization step by recursively computing an IFCM in a single multi-class prediction head. The single multi-class prediction head receives class token feature vectors from a pretrained, self-supervised transformer model and is able to achieve the same optimal performance as a non-incrementally trained classifier in a jointly optimal manner over a set of increasing classes.

### CROSS-REFERENCE TO RELATED APPLICATIONS

The present application claims the benefit of priority to U.S. Provisional Patent Application No. 63/579,144 entitled JOINTLY OPTIMAL INCREMENTAL LEARNING WITH SELF-SUPERVISED VISION TRANSFORMERS filed Aug. 28, 2023, which is incorporated herein by reference in its entirety.

Cross-reference is made to commonly-owned U.S. application Ser. No. 17/083,969 entitled DEEP RAPID CLASS AUGMENTATION filed Oct. 29, 2020, U.S. application Ser. No. 17/840,238 entitled METHOD AND SYSTEM FOR ACCELERATING RAPID CLASS AUGMENTATION FOR OBJECT DETECTION IN DEEP NEURAL NETWORKS filed Jun. 14, 2022 and U.S. Provisional Patent Application No. 63/579,151 entitled RIDGE REGRESSION FOR RAPID CLASS AUGMENTATION filed Aug. 28, 2023, which are incorporated herein by reference in their entirety.

### BACKGROUND

### Field of Embodiments

Generally, the field is continuous learning algorithms. More specifically, the field of the embodiments is continuous learning (CL) algorithms that utilize self-supervision's ability to generalize to new classes with a recursive, classifier-centric approach to incremental learning.

### Description of Related Art

Continuous learning (CL) is a machine learning (ML) field concerned with training methods that can learn from a stream of never-ending data. AI agents need CL algorithms to be able to learn new classes and improve upon their old classes when given additional information. This paper examines methods to improve CL algorithms so that AI agents can learn in real-time and adapt to their dynamic environments.

One of the main objectives in CL is to develop methods that can learn new tasks sequentially. Standard optimizers like stochastic gradient descent (SGD) require access to an entire dataset upfront so that that they can stochastically shuffle the dataset's classes into training batches that never continually favor one class. The reason this is necessary is because these standard optimizers have no long-term memory and update their weights based only on the information in a batch. For incremental learning applications where only the new task data is available, this leads these optimizers to overfit on the current task with often significant performance degradation on the previously learned tasks.

This degradation is known as catastrophic forgetting (CF) and is the chief obstacle facing incremental learning algorithms. The lack of an accepted solution to this sequential learning problem, typically results in models having to be retrained over all their classes whenever a new class needs to be added or the statistics of the data change. This retraining approach adds considerable recompute time and data storage requirements since all the previous classes have to be stored for future class updates. This approach is not sustainable for AI agents in the field that need to continuously update their weights with new training data in real-time and with limited memory and compute resources.

Incremental learning is a subfield of CL that focuses on the task of sequential learning while trying to mitigate catastrophic forgetting (CF). Most incremental learning methods assume the solution requires both finetuning a network's feature extraction backbone and its new classifier on the new class data while simultaneously trying to limit the performance degradation on previously learned classes. This is very challenging since the optimizer is updating the feature weights upon which previous classifiers were trained.

Many different incremental learning approaches have been explored and most involve some method of attempting to incorporate the memory of prior classes into the network's backbone update for the new class to reduce CF on previously learned class features. For example, rehearsal methods like iCARL store exemplars from previous classes and replay them during new class training to preserve the memory of the prior classes and mitigate CF. Parametric isolation methods like PathNet mitigate CF by training models or sub-models on one task, freezing those model's weights or sub-weights and then training a new model or sub-model parameter on the new task. Still other approaches use regularization methods like Elastic Weight Consolidation (ECW) to penalize weight updates that interfere with important features from previous classes. The importance of class features is determined using a Fisher Information matrix. Other regularization approaches like ‘Learning without Forgetting’ use the soft labels of previously trained models run on the new class data to preserve memory of the prior classes during the model's update on the new class data.

All these methods make simplifying assumptions that preclude other desirable CL training objectives. For example, all these methods assume that when a new class is added, all the training data for that new class is available. This means that as each new class is added it has enough information to be trained until the class is completely learned. This assumption allows replay methods to be assured of finding the most representative exemplars for a given class. It allows ensemble methods to assume that the class is learned to completion so that it can freeze its weights during the training of future classes. It allows the regularization methods to assume that prior classes have been sufficiently learned so that the statistically important features of those classes can be determined for new class training penalties.

However, the assumption of all new class training data being available at the onset of new class training is incompatible with the CL goal of learning from a stream of increasing information content with mixed classes. It also ignores the very desirable CL goal of being able to revisit tasks with additional training data. And the CL objective of being able to train on data that is not clearly segmented into one-class increments or in other words being able to train without clear task boundaries. This assumption also glosses over the goal of rapid online learning, thereby allowing solutions that require offline, multi-episodic passes over all a class's training examples.

Another common approach in these incremental learning techniques is the use of multiple single-class prediction heads as opposed to one multi-class prediction head. This use of separate single task prediction heads prevents these techniques from jointly optimizing their weights across the entire set of classes. It also increases their training times and inference times. Incremental learning methods, such as rehearsal and replay whose memory banks grow as additional data and classes are added, also ignore the CL goal of having a constant memory component for learning over long streams of data. And perhaps the most important limitation of all these incremental learning methods is that they can neither justify theoretically nor consistently demonstrate the ability to eliminate CF during sequential training.

### SUMMARY OF THE EMBODIMENTS

In first exemplary embodiment, a system for incrementally training a classifier to continuously learn new classes and classify incoming data includes: a processing component for formatting incoming data for feature extraction; a feature extraction backbone for (i) multiplying formatted data with a positional embedding; (ii) transforming, by an encoder, formatted data with positional embedding to produce an encoded vector; (iii) appending a class token to the encoded vector; a single head incremental classifier trained on one or more known classes for (iv) receiving, by a classification weight matrix wk, where k denotes the kth training update, the encoded vector and determining that the incoming data is in a new class; (v) augmenting the classification weight matrix with a new null-class weight vector Δwk; and (vi) training the incremental classifier on training data having feature samples corresponding to the incoming data directed to the new class.

In a second exemplary embodiment, a non-transitory computer-readable storage medium having computer-executable instructions stored thereon for classifying incoming data, which when executed by one or more processors, cause the one or more processors to perform operations including: formatting incoming data for feature extraction; multiplying formatted data with a positional embedding; encoding formatted data with a positional embedding to produce an encoded vector; appending a class token to the encoded vector; receiving the encoded vector at an incremental classifier and determining by a classification weight matrix that the incoming data is in a new class; augmenting the classification weight matrix with a new null-class weight vector Awk; and training the incremental classifier on training data having feature samples corresponding to the incoming data directed to the new class.

### BRIEF DESCRIPTION OF THE FIGURES

Example embodiments will become more fully understood from the detailed description given herein below and the accompanying drawings, wherein like elements are represented by like reference characters, which are given by way of illustration only and thus are not limitative of the example embodiments herein.

FIG. 1 provides a block diagram of an exemplary XRCA incremental learning classifier in accordance with an embodiment herein;

FIG. 2 provides experimental results for comparison of XRCA Incremental Learning with Supervised and Self-Supervised Features on 10 ImageNet Classes in accordance with an embodiment herein;

FIG. 3 provides experimental results for comparison of XRCA Incremental Learning with Supervised and Self-Supervised Features on 196 Stanford Car Classes in accordance with an embodiment herein;

FIG. 4 provides experimental results for comparison of Final XRCA Incremental Learning Accuracy with Supervised and Self-Supervised Features over Last 20 CAR Classes in accordance with an embodiment herein;

FIG. 5 provides experimental results for comparison of Final XRCA Incremental Learning Accuracy with Supervised and Self-Supervised Features over all 196 CAR Classes in accordance with an embodiment herein;

FIG. 6 illustrates results of XRCA Incremental Learning with Finetuned Features on 196 in accordance with an embodiment herein;

FIG. 7 illustrates experimental results for comparison of XRCA Incremental Learning using Finetuned, Self-Supervised and Supervised Features on First 50 Stanford Car Classes in accordance with an embodiment herein;

FIG. 8 illustrates experimental results for comparison of XRCA Incremental Learning using Finetuned, Self-Supervised and Supervised Features on Last 146 Stanford Car Classes. Does not include first 50 finetuned car classes in accordance with an embodiment herein;

FIG. 9 illustrates XRCA Eliminating Catastrophic Forgetting Using Small DINO Model with Feature Dimension=386 in accordance with an embodiment herein; and

FIG. 10 illustrates XRCA and SGD New Class Training Accuracy Using Base DINO Model with Feature Dimension=768 in accordance with an embodiment herein.

### DETAILED DESCRIPTION

The present embodiments lie at the intersection of self-supervision and incremental learning technologies. The embodied approach directly transfers the frozen feature weights from a pretrained, self-supervised model to a downstream classifier for incremental learning. The self-supervised backbones produce class-agnostic features that generalize well to a wide array of classes, simplifying CL algorithm development so that it can focus on a classifier-centric approach. With this approach, it is no longer necessary to incrementally finetune a network's backbone for each new class.

extending Rapid Class Augmentation (“XRCA”) is based on a recursive least-squares (RLS) solution that has been modified for incremental learning. It uses the inherent RLS memory that incorporates information about all the past training examples into each optimization step by recursively updating an inverse feature covariance matrix (IFCM) using the Matrix Inversion Lemma. This IFCM acts as XRCA's primary memory component and effectively resolves all the typical forgetting issues that arise for standard optimization techniques like SGD that retain no memory or informational context outside of the current batch.

Its recursive approach to memory means that the order with which the samples arrive or the mixture of samples within a batch is unimportant, and its incremental solution will have the same jointly optimal accuracy across all trained classes as its non-incremental solution. In other words, this recursively computed solution eliminates the CF that occurs with standard batch-based optimization methods.

This makes XRCA distinct from other incremental learning approaches. For example, XRCA does not require the replay method's storage of prior class features or the ensemble method's storage of multiple class models or sub-models. Nor does it use the optimization constraints and cost penalties that characterize the regularization approaches.

This recursive approach allows an XRCA classifier to optimally learn in an online manner. It allows seamless class updates and task revisit capabilities. It also allows training on incrementally mixed class batches with no requirement for distinct task boundaries. In addition, XRCA's IFCM memory does not grow as additional training samples are added. This gives it a constant memory component which enables learning over very long data streams with limited memory.

A key algorithmic distinction of XRCA is that, instead of initializing the new class weights randomly, it recursively computes and maintains a null-class weight vector that is used to initialize any new class. This null-class weight vector is updated recursively on all the training samples using a negative label. The idea is to view the initialization of a new class as simply a class for which there has been no prior positive training examples. In other words, by training a null-class weight vector over all the previously seen training data using a negative label we have the optimal least-squares initialization for any new class.

This allows the XRCA method to incrementally train a multi-class classifier so that it is jointly optimized over both old and new classes. To our knowledge XRCA is the only incremental learning method that eliminates CF while jointly optimizing over the set of old and new classes. It also means XRCA learns new classes orders of magnitude faster and with greatly reduced memory and compute resources than a standard SGD classifier that needs to store and retrain over all of the prior classes to perform an update and achieve optimal performance.

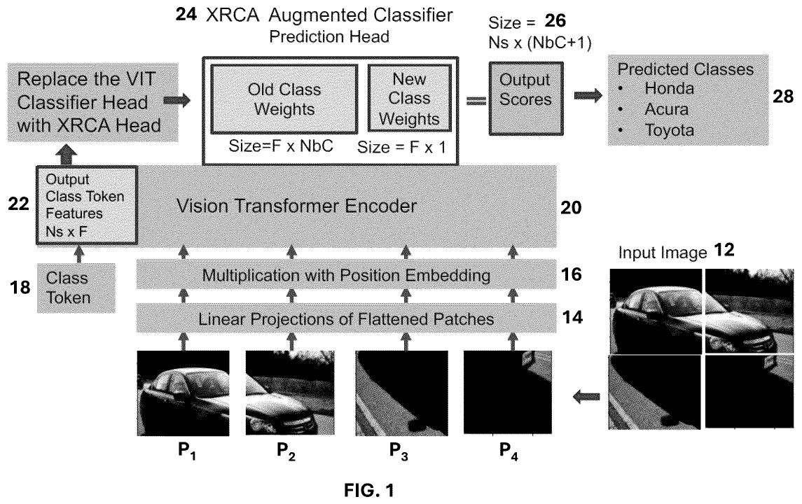

FIG. 1 shows the block diagram of the proposed architecture 5, which is essentially a vision transformer (VIT) network with its classifier replaced with an XRCA incremental learning prediction head. More specifically, the inputs to the architecture are images 12 divided into a grid of non-overlapping contiguous square image patches of resolution N×N (e.g., N=16 or N=8). The patches are flattened and then passed through a feed forward layer to form a set of linear patch projections 14 of P₁, P₂ . . . Px which are multiplied with some positional coding 16, and appended with a learnable token, e.g., class token 18, to form a high-dimensional vector representation, e.g., matrix, which is then fed into the vision transformer encoder 20. The role of class token 18 is to aggregate information from the entire sequence.

The transformer encoder 20 uses a series of transformer blocks, each transformer block including a multi-head self-attention layer and a feed-forward layer. Each multi-head self-attention layer contains multi-head attention (MHA) modules used to find the important correlations between the layer's separate token embeddings. The MHA outputs from each layer are summarized using a multi-layer perceptron (MLP) module and the MLP outputs serve as the new token embeddings for the next layer. The final layer's class token is used as the feature vector 22 that summarizes the image and is fed into the network's classifier 24. FIG. 1 shows that the standard VIT's classifier module is replaced with an XRCA incremental learning classification head.

In the image classification domain, each self-attention layer calculates attention weights for each pixel in the image based on its relationship with all other pixels, while the feed-forward layer applies a non-linear transformation to the output of the self-attention layer.

The resulting class-token embedding 22 is the feature vector upon which the XRCA or R3CA classifier 24 operates to generate output scores 26 and assign a class prediction 28. During incremental training, when a new image class becomes available, the R3CA classification matrix is augmented with a new null-class vector and then trained on feature samples corresponding to the new image and label. During inference, the R3CA classifier operates on a feature embedding and outputs a classification score 26 that is jointly optimized over all classes in the training set.

Additional details describing the use of multi-head attention layers in transformer encoders can be found in Vaswani et al., Attention Is All You Need, NIPS (2017), which is incorporated herein by reference. Additional details describing the use of transformer architectures for computer vision can be found in Dosovitsy et al., An Image is Worth 16×16 Words: Transformers for Image Recognition at Scale, rXiv:2010.11929v2 [cs.CV] 3 Jun. 2021 which is incorporated herein by reference.

In the example shown in FIG. 1, the weights of the VIT encoder 15 are pretrained on the ImageNet dataset using the DINO algorithm for the pretraining task. One skilled in the art will appreciate that different self-supervised VIT models may be used and that the use of DINO is merely exemplary. The architecture has a patch size of 8, a feature dimension of 768, and 6 multi-prediction heads in each of the 12 encoder layers. The class token features 20 from the VIT backbone are used by the incremental classifier 10 for both training and inference.

The XRCA method is based on a modified RLS to address the incremental learning task and is described in detail in co-owned U.S. application Ser. No. 17/083,969. An XRCA model consists of 3 core elements: 1) a classification weight matrix, wₖ, 2) an inverse feature covariance matrix (IFCM), Mₖ; and 3) a null class vector Δwₖ where the subscript k denotes the kth training update. It's linear, classification weight matrix wₖ maps a network's backbone features to its classes. Its IFCM Mₖ stores previously seen feature correlation data and acts as the model's primary memory. The null-class vector Δwₖ is used to initialize a new class using all the prior class information of what it is not. It is computed in a recursive manner by updating its weights using feature data with all negative labels. This is seen to provide the optimal LS initialization for any new class.

The components of an XRCA model are initialized using a feature matrix containing the base model's classes: X₀∈ [symbol] ^{N×F}, of size N samples×F feature dimensions and a label matrix T₀∈ [symbol] ^{N×C} composed of stacked signed, one-hot labels of shape N×C, where C is the number of classes. Eq. (1) shows XRCA's initialization equations:

$${M}_{0} = {( {X}_{0}^{T} {X}_{0} )}^{- 1} \qquad ( 1 )$$

$${w}_{0} = {M}_{0} {X}_{0}^{T} {T}_{0}$$

$$Δ {w}_{0} = {M}_{0} {X}_{0}^{T} {T}_{Neg}$$

These three regularized elements: M₀∈ [symbol] ^{F×F}, w₀∈ [symbol] ^{F×C}, Δwₖ∈ [symbol] ^{F×1} make up the components of an XRA base model and will be recursively updated as the additional data is presented. The T_{Neg} term appearing in the null class's Δwₖ equation consists of a vector of −1's of dimension N×1, representing negative labels for all base model examples.

For each new batch of additional training data, the XRCA algorithm first looks to see if any samples in the batch contain new class labels. If a batch contains only existing class data (i.e., all class labels are less than the number of columns in the current classifier), the XRCA algorithm computes the RLS updates and the new update for the null-class initialization vector Δwₖ, as seen below in Eq. (2)

$${M}_{k + 1} = {M}_{k} - {M}_{k} {{x}_{k + 1}^{T} ( 1 + {x}_{k + 1} {M}_{k} {x}_{k + 1}^{T} )}^{- 1} {x}_{k + 1}^{T} {M}_{k} \qquad ( 2 )$$

$${w}_{k + 1} = {w}_{k} + {M}_{k + 1} {x}_{k + 1}^{T} ( {T}_{k + 1} - {x}_{k + 1}^{T} {w}_{k} )$$

$$Δ {w}_{k + 1} = Δ {w}_{k} + {M}_{k + 1} {x}_{k + 1}^{T} ( {T}_{Neg} - {x}_{k + 1}^{T} {w}_{k} )$$

If a batch contains a new class label (i.e., the label is greater than the number of columns in the current classifier), the XRCA algorithm first augments the existing classification matrix wₖ, with a null-class vector Δwₖ as shown in Eq. (3).

$${w}_{k} = [ {w}_{k ,} Δ {w}_{k} ] \qquad ( 3 )$$

The new augmented classifier wₖ is then passed to the update equations in Eq. (3) and trained with the new xₖ₊₁ training data sample or batch.

The experimental results summarized herein show incremental learning algorithms no longer need to individually finetune their network's feature extraction backbones on new class data given the advent of self-supervised vision methods and their excellent ability to generalize well to a wide variety of downstream tasks. Specifically, the experiments use the XRCA incremental learning classifier with features from various VIT's pretrained using supervision, self-supervision, finetuning and domain adapted techniques. The XRCA's incremental learning ability is compared with prior art SGD in terms of CF and augmentation training times to exemplify the improvements.

In a first experiment, the XRCA system and process of FIG. 1 is used on the ImageNet dataset. The goal of the first experiment is to baseline XRCA's incremental learning capabilities and assess whether self-supervised features can compete with the supervised features when trained over the same dataset but without labels. The features are obtained using two VIT backbones pretrained on the ImageNet dataset. One backbone is pretrained with supervision (S-VIT) and the other pretrained with DINO's self-supervision (SS-VIT). Both backbones use the base VIT architecture with a feature dimension of 768.

The utility of the differently trained features is measured using an all-class accuracy performance metric which measures the accuracy over the entire test dataset which in this case contains 10 classes. By applying this metric after each successive new class augmentation, we can observe the growing classification capacity of the model. The experiment measures the all-class accuracy of these pretrained models on the ImageNette dataset which is a 10-class subset of the original ImageNet data.

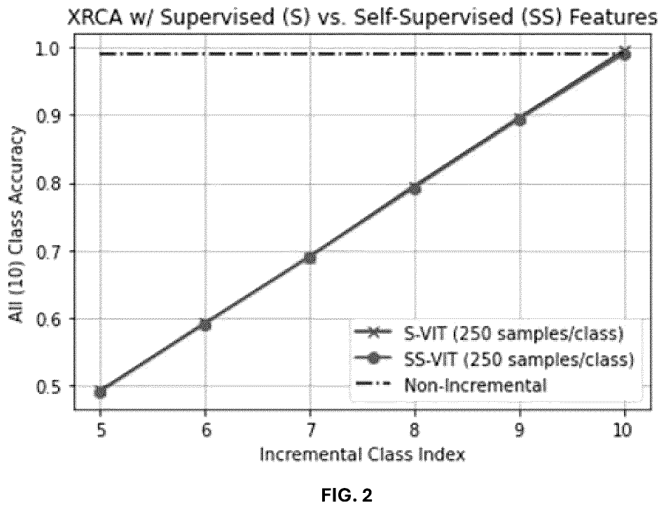

XRCA's all-class accuracy using the features from the two pretrained backbones is shown in FIG. 2. The XRCA classifier is first initialized on 5 classes of the ImageNette dataset, and the remaining 5 classes are added incrementally using just the new class features. We used 250 training samples per class.

FIG. 2 shows that the S-VIT and SS-VIT feature sets perform equally well and they both reach the final accuracy of almost 100% after training over all 10 classes. These results indicate that DINO's self-supervision method can produce features that are as useful for linear classification as the supervised features are but without the extra overhead and expense of annotating or labeling the dataset. They herald the arrival of self-supervised techniques in general and allude to potentially even better performance as future self-supervised models will be pretrained over much larger unlabeled datasets than the original ImageNet and its 1000 classes.

FIG. 2 also points out the unique incremental learning properties of the XRCA algorithm. It shows that XRCA can incrementally learn on just the new class data while avoiding any CF. This is observed by XRCA's all-class accuracy linearly increasing in the ideal manner to meet the nearly 100% non-incremental solution accuracy that has access to all class data upfront. The ideal non-incremental, jointly optimized classification accuracy is displayed in the FIG. 2 as a dashed black-line to represent an upper-bound for incremental learning performance.

The results empirically confirm the theory that an optimal least-squares solution can be recursively obtained using the Matrix Inversion Lemma and XRCA's null-class vector for new class initialization.

Experiment 2 explores the central theme of this paper by examining the potential of self-supervised, pretrained vision backbones to transfer directly without finetuning to previously unseen downstream tasks.

Experiment 2 reuses the S-VIT and SS-VIT from Experiment 1 above and directly transfers their features to the new downstream task of car classification. In this experiment, the XRCA classifier is initialized on the first 50 cars in the Stanford CARS196 dataset and then incrementally trained over the remaining 146 cars using just the new class data.

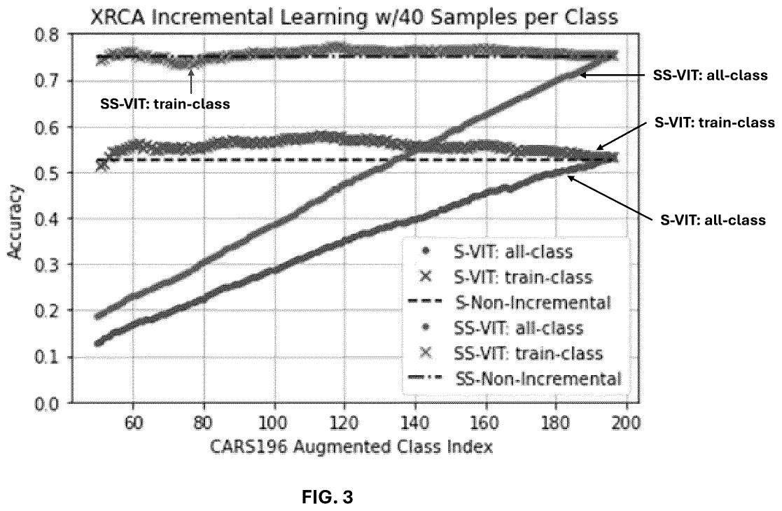

FIG. 3 highlights self-supervision's significant performance improvement over supervised features for classification for the important use case when the set of classes is outside the original supervised pretraining dataset. One can once again observe that XRCA's all-class accuracy rises to meet the non-incremental accuracy on either the supervised or the self-supervised features.

To these metrics a new train-class metric is also added. The train-class metric measures the classifier's accuracy over previously trained classes. It provides a clearer measurement of an incremental learning algorithm's ability to avoid significant degradation on previous classes as new classes are added. The train-class metric shows that the classification accuracy on previously learned classes stays roughly constant and does not experience any significant degradation. Notably, it converges to the ideal non-incremental learning accuracy as the final classes are incorporated.

These results show an approximately 25% increase in the overall classification performance for an XRCA classifier using the self-supervised features as opposed to the supervised features. The strong separation between the self-supervised features and the supervised features supports our hypothesis that the self-supervised features can generalize better to new classes than the supervised features that were trained explicitly on a different set of tasks.

On the one hand, the supervised features' relatively poor incremental learning classification accuracy seems to motivate the approach of most incremental learning approaches to improve performance by sequentially finetuning the backbone on the additional classes. On the other hand, the relatively good incremental learning accuracy of the self-supervised features asks the question if this finetuning approach is still necessary, especially given the potential of even better generalization once future self-supervised models are pretrained over the larger and more abundant data sources.

In other words, given the success of self-supervision to produce features that generalize well to downstream tasks, the sequential finetuning approaches pursued by most incremental learning algorithms might become irrelevant. These findings increase the utility of classifier-focused incremental learning, like XRCA that are well-positioned to leverage these self-supervised techniques for continuous learning objectives.

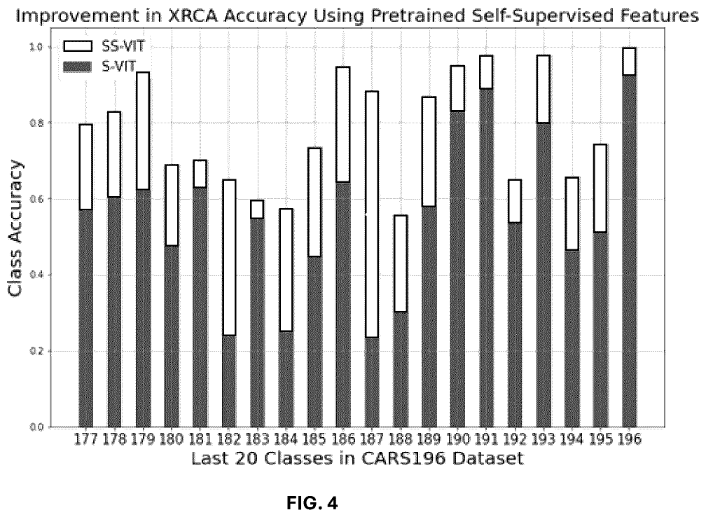

These findings are further highlighted in FIG. 4 which contrasts the individual classification accuracy of a fully trained XRCA classifier on supervised versus self-supervised features on the last 20 classes of the CARS196 dataset. In all cases the self-supervised features are seen to yield a higher classification accuracy on the new downstream tasks.

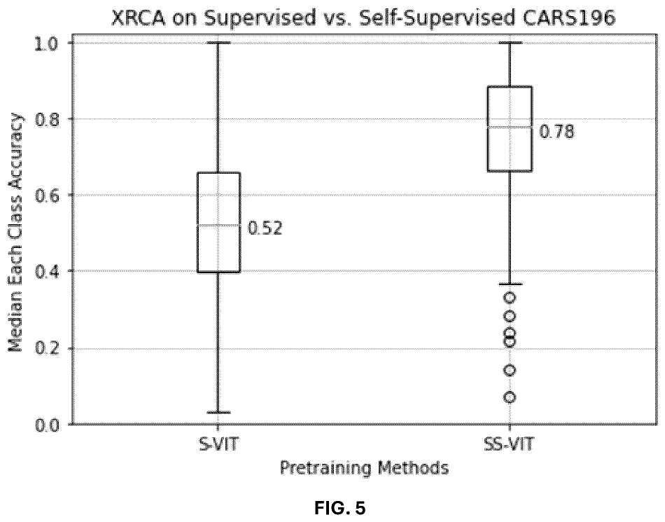

FIG. 5 provides the boxcar plots of accuracy performance from Experiment 2's classifiers over all the 196 CARS classes. It shows that the incrementally trained classifier using a self-supervised backbone achieved a 78% median classification accuracy as compared with a 52% accuracy with the supervised backbone. This is a significant finding that results in the self-supervised features achieving a 50% improvement median performance over the supervised features and illustrates the potential of self-supervised features for incremental learning models.

Experiment 3 seeks to quantify the upper bound for the classification task if we first could finetune the VIT backbone on the downstream CARS196 classes and then incrementally learn those classes using XRCA. This sort of finetuning approach is often not possible for many CL applications that do not have the luxury of pretraining their backbones over known future classes. This limitation is probably what originally motivated the other incremental learning techniques to take on the difficult challenge of finetuning incrementally on the new class data.

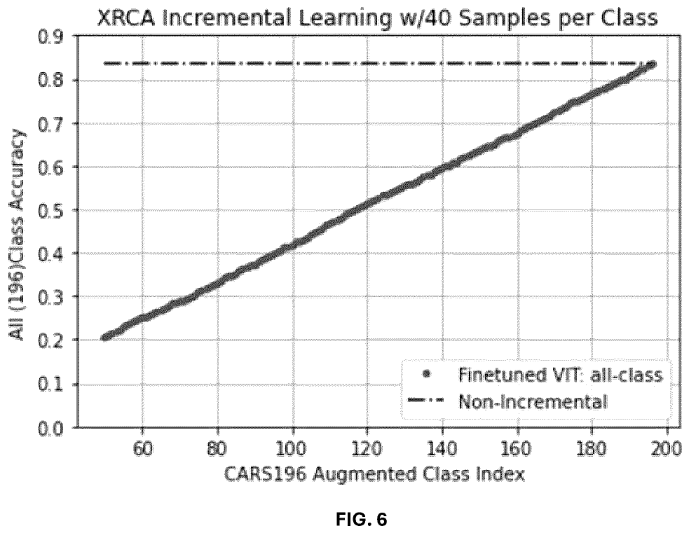

FIG. 6 shows XRCA's all-class accuracy after it is initialized on the first 50 CARS classes and then incrementally trained over the remaining 146 CARS classes. XRCA's finetuned accuracy was 83% accuracy over all 196 classes. This indicates a 5% increase in classification performance over the self-supervised model and a 30% increase over the supervised features.

Experiment 4 uses a simple form of domain adaptation to see if it is advantageous to finetune a pretrained backbone over similar but different car classes. The hope is that it will help the feature extraction backbone learn important car features that will generalize well to future car classes. This scenario represents a more realistic use case where the genre of future classes is more likely known and there are a limited set of representative genre training examples available but the exact future classes are unknown.

The experiment is divided into two parts. First, a VIT model is finetuned over the first 50 cars in the CARS196 dataset to learn the domain-adaptation to the CARS genre. Second, that domain-adapted backbone is used to extract the features over the remaining set of 146 classes, that it has not previously seen. The performance of an incremental learning XRCA classifier operating on these 146 classes of domain-adapted features will also be compared to the supervised and self-supervised counterparts.

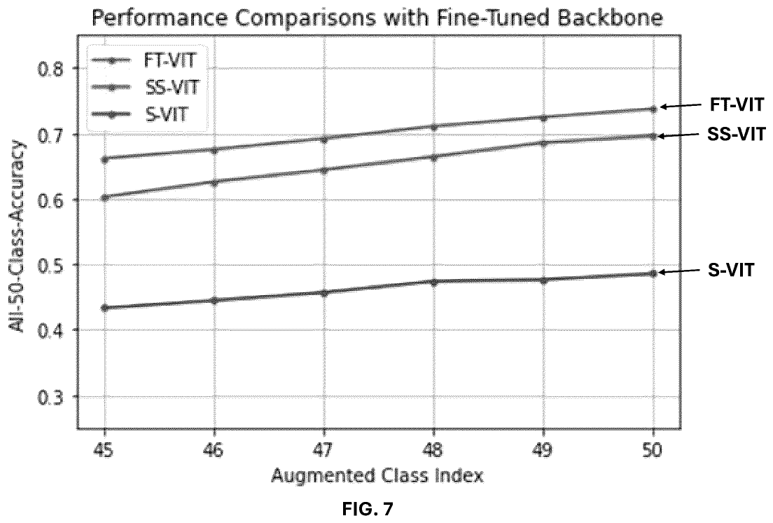

FIG. 7 examines the XRCA classification performance on the first 50 car classes on which its backbone was finetuned. It plots the all-50-class accuracy of XRCA starting with its 45-class base-model accuracy and its sequentially added last 5 classes. The results show that the finetuned VIT (FT-VIT) again outperforms the self-supervised classifier by ˜5% and the supervised classifier by ˜30% and confirms that the finetuned model performed well over the set of classes it was trained on.

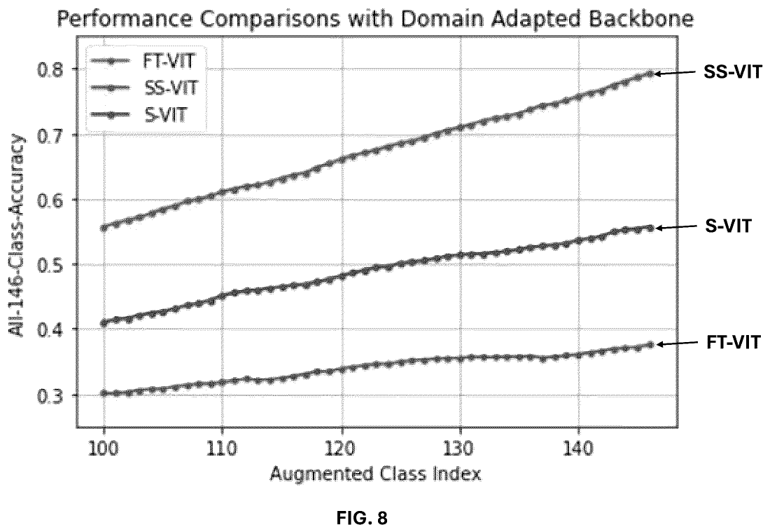

FIG. 8 shows the results for the second part of this experiment, comparing XRCA's classification performance using the domain adapted features and the supervised and self-supervised features over the remaining 146 (not including the first 50 cars) downstream car classes. This is the more realistic incremental learning scenario where the specific future classes are not known at the time either the backbone, or the classifier, are initialized.

In this example, the XRCA classifier is initialized on the first 100 of these 146 classes and then incrementally trained on the remaining 46 classes. The results show that now all the performance rankings are flipped, with the self-supervised features doing much better than the supervised features, which in turn perform better than the domain-adapted features. These results illustrate the difficulty of using finetuning over similar classes for domain-adaption to a given genre. They indicate that the finetuned backbone can easily be overfit to the smaller domain relevant dataset and in the process lose its ability to transfer well to unseen new classes.

This result also highlights the challenge for conventional incremental learning algorithms to avoid overfitting on the current new class while finetuning the model on the incrementally available new class data. It supports the idea that pretraining a self-supervised model on a large dataset may have a better chance of producing features that generalize to unseen future classes than trying to finetune a model on a limited data set to improve domain relevance. These results once again support the use of incremental learning algorithms that can leverage these pretrained, self-supervised features for downstream classification.

Experiment 5 compares XRCA's incremental learning with a standard SGD optimizer in an incremental learning application to highlight XRCA's ability to eliminate CF. Both classifiers are trained with the features produced by a small vision transformer (SS-VIT) architecture that has a feature dimension of 386 and is pretrained using DINO on ImageNet and transferred to the CARS 196 dataset. Both classifiers are initialized with the same base model over the first 195 cars and have the same train-class performance.

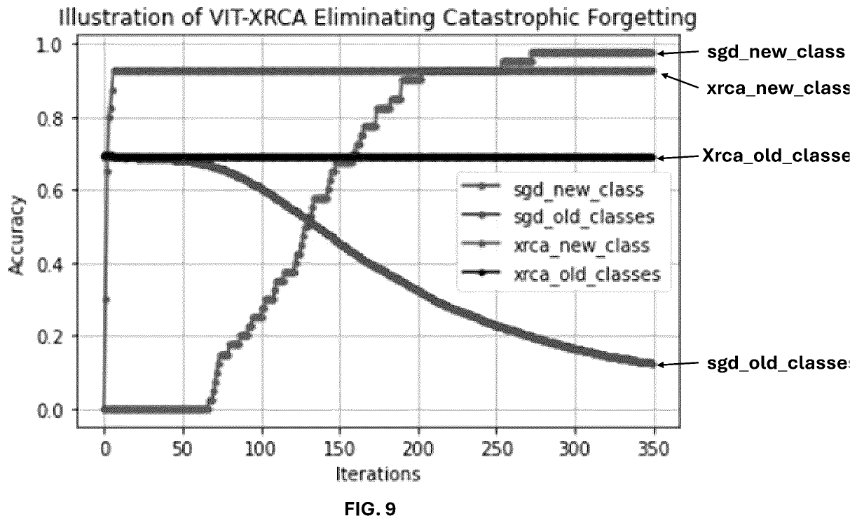

The experiment begins by augmenting both classifiers with the final 196th CAR class and updating each classifier's weights using just that class data. FIG. 9 shows both the new 196th class accuracy and the old class accuracy over the 195 previously learned car classes, for each classifier. These results show that XRCA can learn the new class over multiple batch iterations while not degrading the performance on the old classes. They also highlight XRCA's rapid online learning of the new class with just a few batches of data relative to SGD classifier.

FIG. 9 also shows how when SGD learns the new class, its old class performance suffers. This is a classic illustration of the ‘catastrophic forgetting’ that is known to plague sequentially trained SGD models. This CF means that in order for conventional optimizers to add new classes it essentially has to retrain over all the previous class data so that the batches are not biased towards the new class features. This leads to significant increases in storage requirements and compute time when using these standard optimizers for continuous learning applications.

The final experiment conducts a timing comparison that demonstrates the significantly faster augmentation rates enabled by the XRCA incremental learning algorithm. We use the same FT-VIT feature extraction backbone with a feature dimension of 768 previously pretrained on CARS196 for both the XRCA and SGD classifier. Each classifier was initially trained on 195 car classes, and both achieved classification accuracies of ˜83% on these classes. Each method was then timed for the period it took to augment and train its classifier with a new class.

The XRCA classifier was augmented using just the new class training data. It learned the new class with a test accuracy of 100% in 0.007 seconds while preserving its old class accuracy. The SGD classifier took 13.878 s to learn its new class while training over all the classes to maintaining previous class performance. This is 1900× slower than XRCA. These times are shown in Table 1.

TABLE 1
Performance Metrics After Learning 196th Car Class

| | Old | New | | |
|---|---|---|---|---|
| | Class | Class | Train | |
| | Accuracy | Accuracy | Time | Faster |
| SGD | 82.5% | 93.7% | 13.878 s | |
| XRCA | 82.8% | 100.0% | 0.007 s | 1900x |

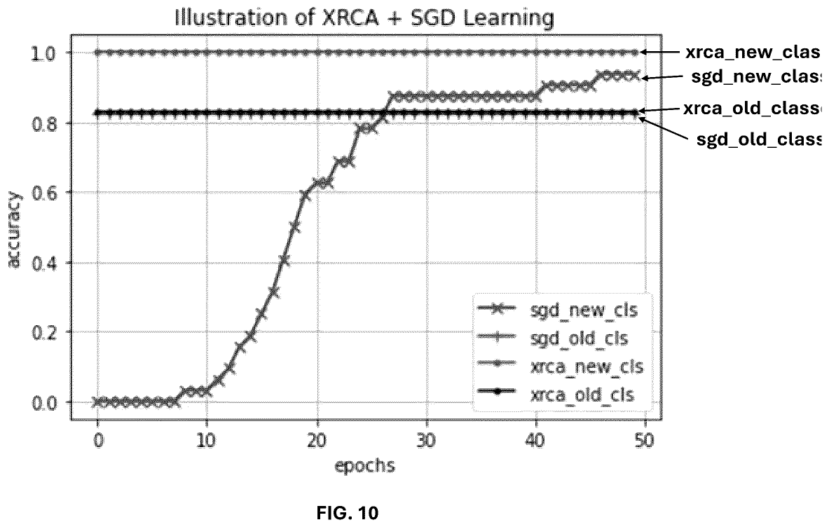

FIG. 10 shows the plot of SGD learning the new 196th class while this time remembering its old classes. In this plot the x-axis is in epochs and not batch iterations. XRCA learns the new class in fractions of an epoch and so its new class and old classes accuracies appear constant at this time scale.

The reason SGD is so much slower is that it must be trained using batches containing roughly equal mixtures of all its 196 classes. This means that the new class data is lightly sprinkled into its training batches which significantly increases the amount of time necessary update the SGD. Furthermore, as the number of previously learned classes grows, the longer it takes for SGD and other non-incremental methods to learn the new class while also avoiding CF.

Note this time does not include the time to extract the features from the images and so in some sense represents the best time case for SGD. If feature extraction time is included the XRCA classifier can be updated in under 1.5 seconds while the SGD model takes over 8000 seconds to extract all the image features over the 50 training epochs.

The embodiments herein describe the advantages of using the XRCA incremental learning technique with a self-supervised VIT backbone. The results of the disclosed experiments show that a self-supervised backbone produces features that generalize significantly better to new classes and ultimately yielded improved incremental learning over the pretrained supervised features. The results also show that care must be taken when using supervision to domain-adapt a backbone to similar but different classes. XRCA's rapid learning and ability to eliminate catastrophic forgetting was compared with an SGD progressive learning implementation and shown to be over 1000× faster.

Exemplary hardware (also referenced herein as “chip(s)”) and hardware functions for implementing the embodiments described herein are well known and understood to those skilled in the art. Chips for use with the present embodiments include logic functionality implemented through semiconductor devices, e.g., millions or billions of transistors (MOSFET) (also called “nodes”) and electrical interconnects, for creating basic logic gates to perform basic logical operations. These basic logic gates are combined to perform complex high volume, parallel computing required for the training and inference of the models of the embodiments described herein. Chips may also include memory capabilities for storing the data on which the logic functionality is implemented. Exemplary memory capabilities include dynamic random-access memory (DRAM), NAND flash memory and solid-state hard drives.

As referenced above, the training and inference examples described herein were run on an NVIDIA Tesla T4 GPU with 16 GB of GPU memory. Specifications for the NVIDIA Turing GPU architecture can be found in the “NVIDIA Turing GPU Architecture” white paper WP-09183-001_v01 (2018) available on-line which is incorporated herein by reference in its entirety.

One skilled in the art will appreciate that this is but one specific example of a chip which may implement the training and inference embodiments described herein Exemplary chip types include graphics processing units (GPUs), field programmable gate arrays (FPGAs), and application-specific integrated circuits (ASICs). FPGAs include logic blocks (i.e. modules that each contain a set of transistors) whose interconnections can be reconfigured by a programmer after fabrication to suit specific algorithms, while ASICs include hardwired circuitry customized to specific algorithms. The selection of particular hardware includes factors such as computational power, energy efficiency, cost, compatibility with existing hardware and software, scalability, and task (e.g. optimized for training or inference). For a detailed description of AI chip technology, see Khan et al., “AI Chips: What They Are and Why They Matter And AI Chips Reference,” CSET center for Security and Emerging Technology (April 2020) which is incorporated herein by reference in its entirety.

Certain embodiments are directed to a computer program product (e.g., nonvolatile memory device), which includes a machine or computer-readable medium having stored thereon instructions which may be executed by a computer (or other electronic device) to perform these operations/activities.

Although several embodiments have been described above with a certain degree of particularity, those skilled in the art could make numerous alterations to the disclosed embodiments without departing from the spirit of the present disclosure. It is intended that all matter contained in the above description or shown in the accompanying drawings shall be interpreted as illustrative only and not limiting. Changes in detail or structure may be made without departing from the present teachings. The foregoing description and following claims are intended to cover all such modifications and variations.

Various embodiments are described herein of various apparatuses, systems, and methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” “an embodiment,” or the like, means that a particular feature, structure, or characteristic described in connection with the embodiment is included in at least one embodiment. Thus, appearances of the phrases “in various embodiments,” “in some embodiments,” “in one embodiment,” “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features structures, or characteristics of one or more other embodiments without limitation.

Any patent, publication, or other disclosure material, in whole or in part, which is said to be incorporated by reference herein is incorporated herein only to the extent that the incorporated materials do not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

1. A system for incrementally training a classifier to continuously learn new classes and classify incoming data, the system comprising:
a processing component for formatting incoming data for feature extraction;
a feature extraction backbone for
(i) multiplying formatted data with a positional embedding;
(ii) transforming, by an encoder, formatted data with positional embedding to produce an encoded vector;
(iii) appending a class token to the encoded vector;
a single head incremental classifier trained on one or more known classes for
(iv) receiving, by a classification weight matrix wₖ, where k denotes the kth training update, the encoded vector and determining that the incoming data is in a new class;
(v) augmenting the classification weight matrix with a new null-class weight vector Δwₖ; and
(vi) training the incremental classifier on training data having feature samples corresponding to the incoming data directed to the new class.

2. The system of claim 1, wherein the encoder includes multiple self-attention layers to calculate attention weights for the formatted incoming data.

3. The system of claim 1, wherein the encoder includes six layers each including twelve heads.

4. The system of claim 1, wherein the feature extraction backbone is a pretrained, self-supervised, model.

5. The system of claim 4, wherein the pretrained, self-supervised, model is selected from the group consisting of a vision transformer model and a natural language processing (NPL) model.

6. The system of claim 1, wherein each column of the classification matrix estimates a likelihood of a different class.

7. The system of claim 1, wherein augmenting the classification matrix with a new null-class weight vector includes adding a new column for new class weights for the new class.

8. The system of claim 7, further comprising:
initializing the new class weights wherein a new class's column vector weights are weights that have not yet seen any positive class samples and an initial least-squares estimate for the new class weight vector is the recursive solution of all preceding negative training.

9. The system of claim 1, wherein the single head incremental classifier further includes a feature correlation memory.

10. The system of claim 9, wherein the feature correlation memory is an inverse feature covariance matrix (IFCM), Mₖ.

11. A non-transitory computer-readable storage medium having computer-executable instructions stored thereon for classifying incoming data, which when executed by one or more processors, cause the one or more processors to perform operations comprising:
formatting incoming data for feature extraction;
multiplying formatted data with a positional embedding;
encoding formatted data with a positional embedding to produce an encoded vector;
appending a class token to the encoded vector;
receiving the encoded vector at an incremental classifier and determining by a classification weight matrix that the incoming data is in a new class;
augmenting the classification weight matrix with a new null-class weight vector Δwₖ; and
training the incremental classifier on training data having feature samples corresponding to the incoming data directed to the new class.

12. The non-transitory computer-readable storage medium of claim 11, wherein augmenting the classification weight matrix with a new null-class weight vector includes adding a new column for new class weights for the new topic class.

13. The non-transitory computer-readable storage medium of claim 12, further comprising:
initializing the new class weights wherein a new class's column vector weights are weights that have not yet seen any positive class samples and an initial least-squares estimate for the new class weight vector is the recursive solution of all the preceding negative training.

14. The non-transitory computer-readable storage medium of claim 11, wherein formatting incoming data for feature extraction includes extracting multiple flattened image patches from an input image.

15. The non-transitory computer-readable storage medium of claim 11, further comprising: linearly transforming each of the multiple flattened patches, by a patch encoder layer, and mapping the linear transformation to a patch vector prior to encoding with a positional embedding to produce an encoded patch vector.
